(19) United States
(12) Patent Application Publication
(10) Pub. No.: US 2026/0202042 A1
(43) Pub. Date: Jul. 16, 2026

(54) INSTALLATION BOX FOR RECESSED LIGHTING ON THE FLOOR

(71) Applicant: STELLA IMPORTAÇÃO E EXPORTAÇÃO DE LUMINÁRIAS LTDA, Sapiranga (BR)

(72) Inventor: Lisandro Henrique BERLITZ, Sapiranga (BR)

(21) Appl. No.: 19/134,292

(22) PCT Filed: Nov. 30, 2022
(86) PCT No.: PCT/BR2022/050470

§ 371 Date: Nov. 19, 2025

(51) Int. Cl. F21V 21/04

(52) U.S. Cl. CPC F21V 21/04

(57) ABSTRACT

The installation box for recessed lighting on the floor, which is the object of the present invention, comprises an installation box (100) composed of a base (10), ball joint (20) and ring (30) which result in wide space to accommodate electrical splices and an orbital guidance system that allows the luminaire to be rotated and tilted at different angles. This new construction ensures greater practicality and ease of installation, as it allows its application on the floor and masonry with passage for corrugated hoses of varying diameters.

### FIELD OF THE INVENTION

The present invention relates to an installation box for recessed lighting on the floor. More specifically, it comprises an installation box equipped with wide space to accommodate electrical splices and an orbital guidance system that allows the luminaire to be rotated and tilted at different angles.

This new embodiment ensures greater practicality and ease of installation as it allows its application on the floor and masonry with passage for corrugated hoses of varying diameters.

### BACKGROUND OF THE INVENTION

Lighting products for outdoor areas require watertight electrical splices to ensure the safety of the installation for both the inhabitants and the installed products themselves. Therefore, in order to store splices in accordance with the standards, wide space is required in the installation box.

Currently, there are several models of installation boxes designed for outdoor lighting products; however, these products only have a cylindrical tube for storing the electrical splice so as not to accommodate an electrical splice within the standards, making the installation inappropriate and unsafe.

Thus, the present inventor seeking to improve the embodiment has developed a new embodiment applied in an installation box for recessed outdoor lighting that presents wide space for electrical splices and an orbital guidance system that adds greater variability in the movement and direction of lighting into the environment.

In search conducted on the state of the art, we identified several documents describing solutions applied in installation boxes for recessed lighting, where we can highlight the following documents:

CN214790958 (Wuhan. 2021) describes an LED underground lamp installation structure comprising an installation cylinder and a lamp.

WO2020234036 (Signify. 2019) describes recessed luminaires and subassemblies thereof, including a heat sink and pivot for a recessed luminaire, a gasket for the recessed luminaire, an outer box and cover (4) for installing the recessed luminaire (2).

EP3693656 (Bega. 2019) describes a floor luminaire consisting of a housing with a light outlet opening, which is covered by a glazing, a sealing ring between the housing and the glazing, wherein the underside of the glazing rests on a receiving portion of the housing.

EP3408582 (Iguzzini. 2016) describes a recessed lighting apparatus comprising a compartment adapted to contain at least one lighting source and provided with means for orienting said at least one lighting source operable from outside said compartment.

U.S. Pat. No. 10,228,101 (Mind Head. 2015) describes an LED luminaire that includes a die-cast body with an LED mounting area having an outer perimeter surrounded by an outer ring and a shroud covering a portion of the outer perimeter of the LED mounting area. The body housing has elongated slots extending between the LED mounting area and the outer ring.

DE202012008928 (Dot Spot. 2012) describes a lighting device comprising a housing having a light unit disposed within the housing, wherein the lighting unit includes a body having a light source, and wherein the main body of the lighting unit with an outer surface partially to a complementary coupling surface of the housing is mounted on a flat support slide.

U.S. Pat. No. 7,320,533 (Hunter. 2006) describes a floor luminaire comprising a hollow cylindrical housing with an angled end and a flat end, a lamp assembly readily mounted at each end, and a deflector. The lamp assembly is rotatably and vertically adjustable within the housing, and either the angled end or the flat end can be positioned upward by virtue of a pair of channels extending along the length of the housing.

These documents cited in the state of the art describe floor lighting installation boxes equipped with their own construction forms so that none of the cited documents presents an installation box with an embodiment provided with wide space for positioning the electrical splices and an orbital lighting guidance system, which results in greater ease and practicality in installation and adjustments after installation.

Thus, the object of the present invention is an installation box equipped with wide space to accommodate electrical splices and an orbital guidance system that allows the luminaire to be rotated and tilted at different angles. In addition, it allows its application on the floor and masonry with passage for corrugated hoses of varying diameters.

### SUMMARY OF THE INVENTION

The present invention features an installation box for recessed lighting on the floor providing an installation box with wide space to accommodate electrical splices.

The present invention features an installation box for recessed lighting on the floor providing an installation box with an orbital guidance system that allows the luminaire to be rotated and tilted at different angles.

The present invention features an installation box for recessed lighting on the floor providing an installation box that allows its application on the floor and masonry with passage for corrugated hoses of varying diameters.

The present invention features an installation box for recessed lighting on the ground providing an installation box consisting of a base where the corrugated hoses pass through.

The present invention features an installation box for recessed lighting on the floor providing an installation box composed of a ball joint that allows orbital guidance with tilt adjustment at angles of 0°, 5°, 10° and 15° degrees.

The present invention features an installation box for recessed lighting on the floor providing an installation box consisting of a ring that fixes the ball joint to the base.

The present invention features an installation box for recessed lighting on the floor providing an installation box composed of two parts that form the ring for raising the luminaire in relation to the floor.

### BRIEF DESCRIPTION OF THE FIGURES

FIG. 1 shows a perspective view of the installation box for recessed lighting on the floor.

FIG. 2 shows the bottom perspective view of the installation box for recessed lighting on the floor.

FIG. 3 shows the top view of the installation box for recessed lighting on the floor.

FIG. 4 shows a perspective view of the base of the installation box, detailing its embodiment.

FIG. 5 shows the top view of the installation box base, detailing its embodiment.

FIG. 6 shows the bottom view of the installation box base, detailing its embodiment.

FIG. 7 shows the perspective view of the installation box ball joint, detailing its embodiment.

FIG. 8 shows the bottom perspective view of the installation box ball joint, detailing its embodiment.

FIG. 9 shows the front view of the installation box ball joint, detailing its embodiment.

FIG. 10 shows the side view of the installation box ball joint, detailing its embodiment.

FIG. 11 shows the top view of the installation box ball joint, detailing its embodiment.

FIG. 12 shows a perspective view of the installation box ball joint fixing ring, detailing its embodiment.

FIG. 13 shows the bottom perspective view of the installation box ball joint fixing ring, detailing its embodiment.

FIG. 14 shows a perspective view of the installation box ball joint lifting ring, detailing its embodiment.

FIG. 15 shows the top view of the installation box ball joint lifting ring, detailing its embodiment.

FIG. 16 shows the exploded perspective view of the installation box ball joint lifting ring, detailing its embodiment.

FIG. 17 shows the exploded rear perspective view of the installation box ball joint lifting ring, detailing its embodiment.

FIG. 18 shows the side view of the lighting installation box and FIG. 18A shows the sectional view detailing the fixing ring positioned next to the ball joint.

FIG. 19 shows the exploded perspective view of the installation box for recessed lighting on the floor.

FIG. 20 shows a perspective view of the installation box for recessed lighting on the floor with the ball joint in the standard position, FIG. 20A shows a perspective view of the box with the ball joint in the inclined position to the right and FIG. 20B shows a perspective view of the box with the ball joint in the inclined position to the left.

FIG. 21 shows a perspective view of the installation box with the recessed luminaire, FIG. 21A shows a side view of the installation box with the recessed luminaire and FIG. 21B shows a sectional view detailing the recessed luminaire next to the installation box.

FIGS. 22, 22A and 22B show the view of the box with recessed lighting applied on the floor.

FIGS. 23 and 23A show the view of the box with recessed lighting applied to the concrete floor.

FIGS. 24, 24A, 24B and 24C show a view of the box with a recessed luminaire applied on the floor, detailing its normal position and the possibility of changing the light beam at a specific angle.

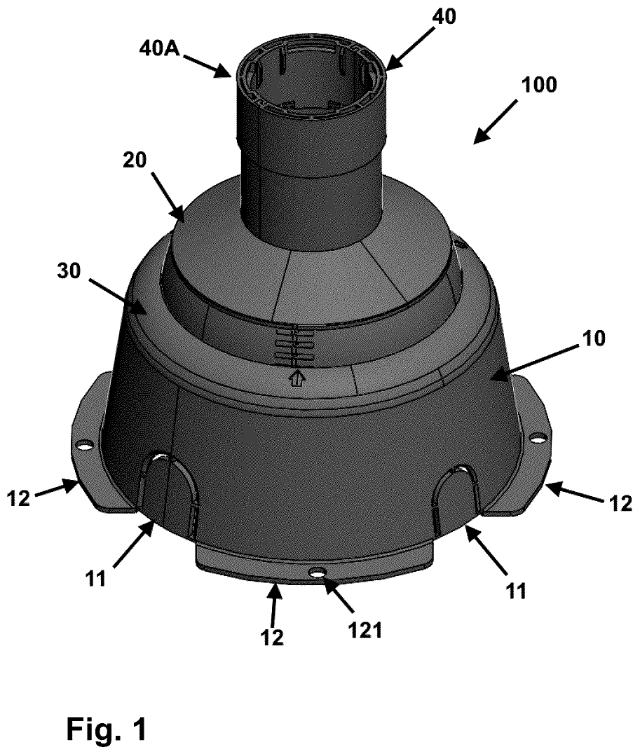

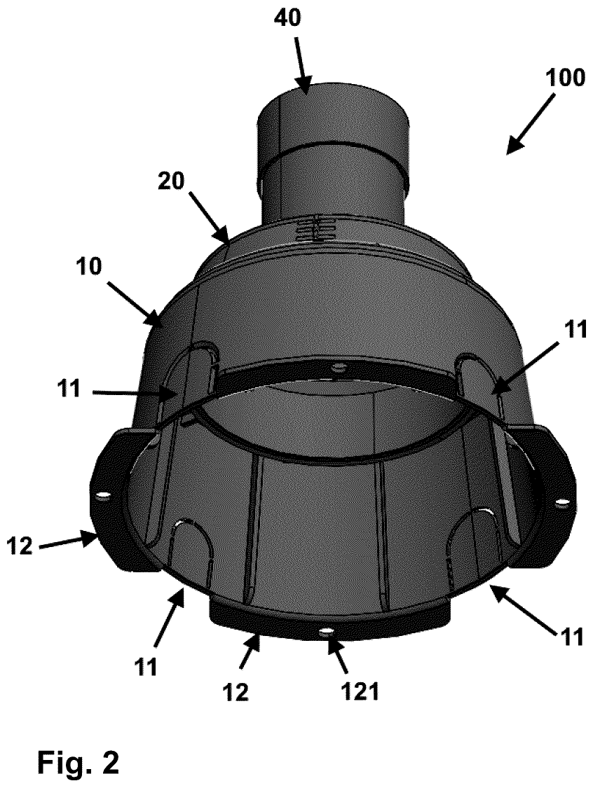

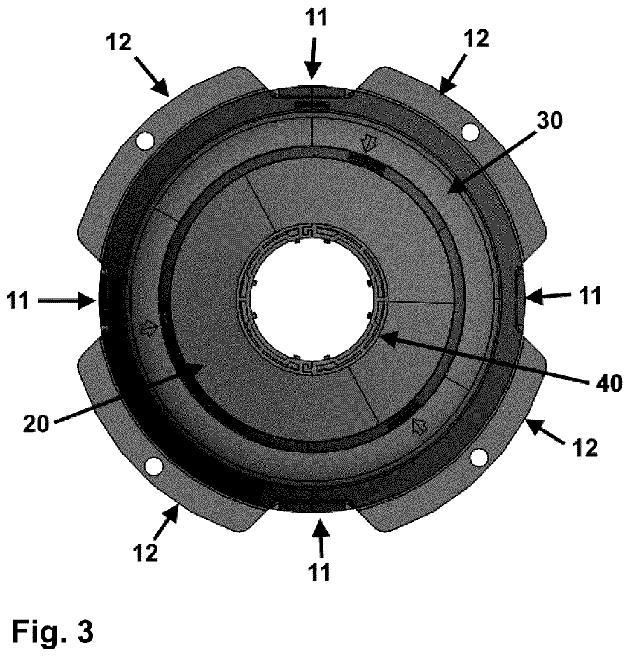

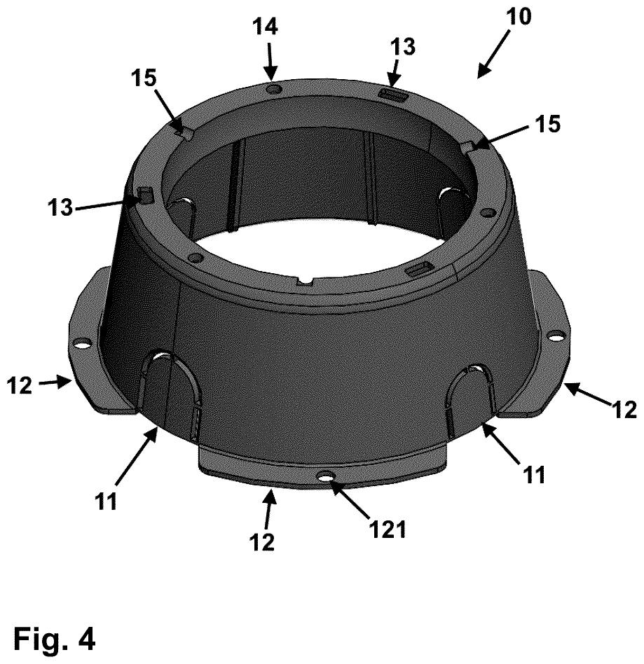

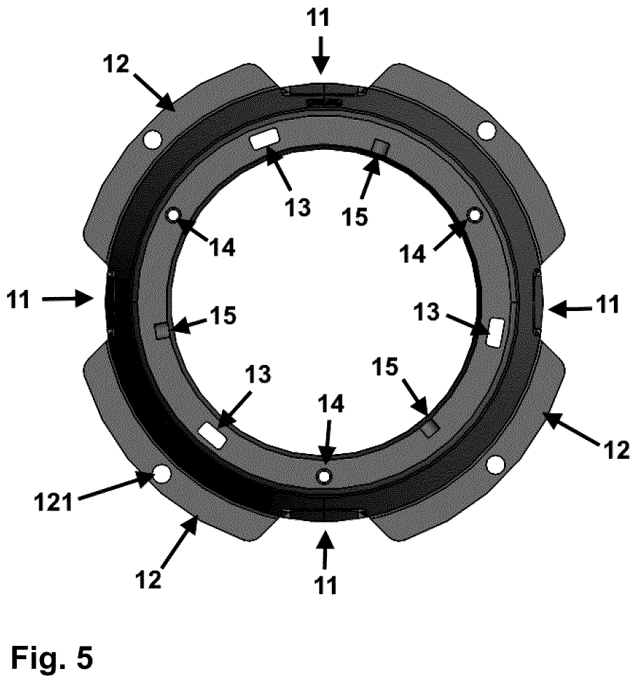

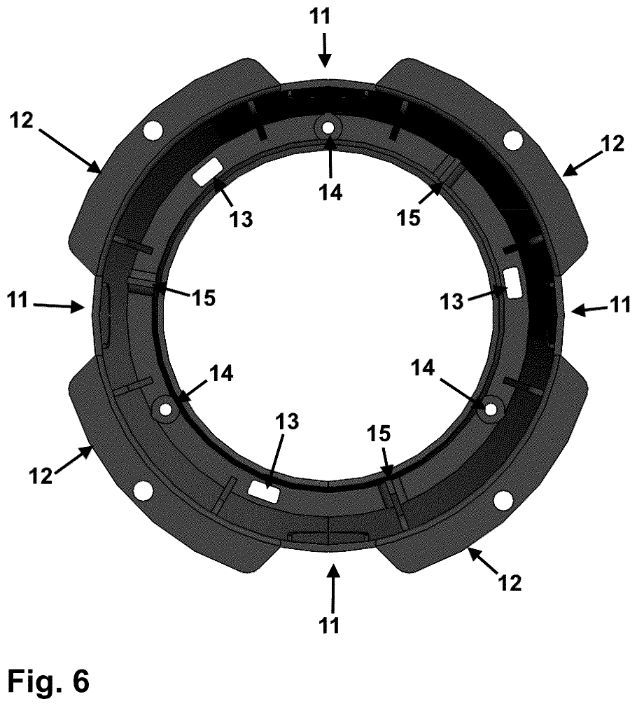

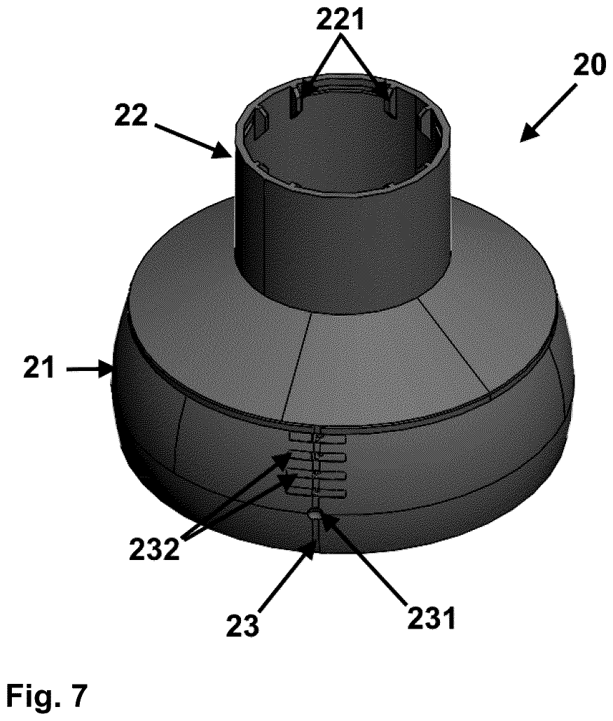

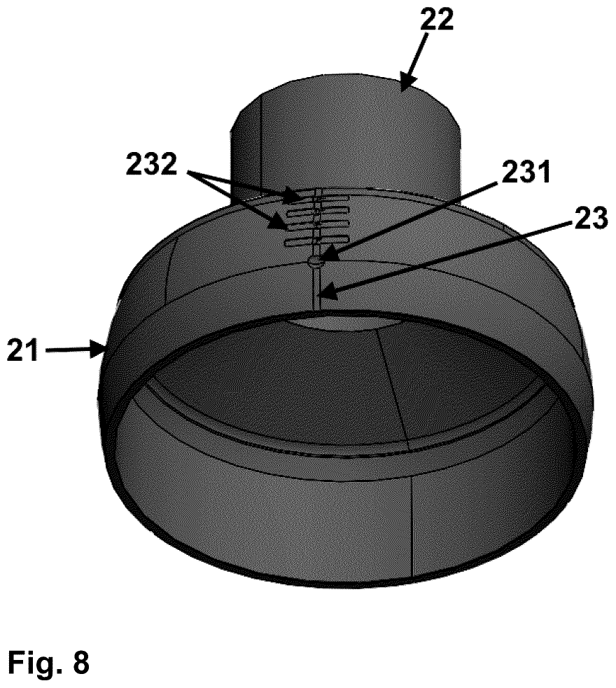

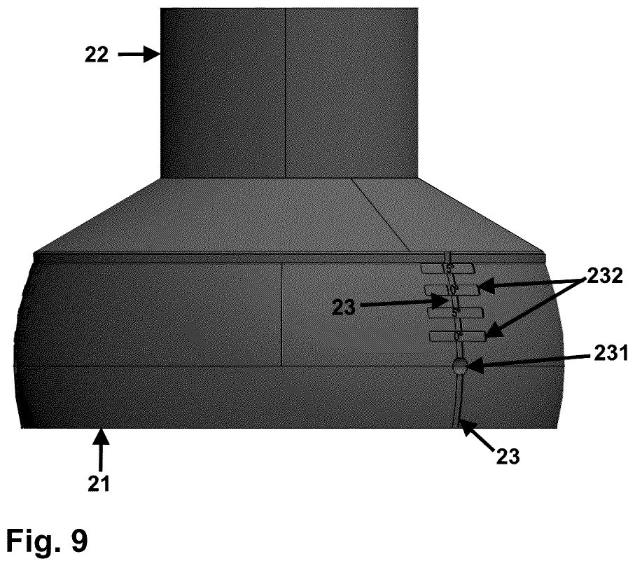

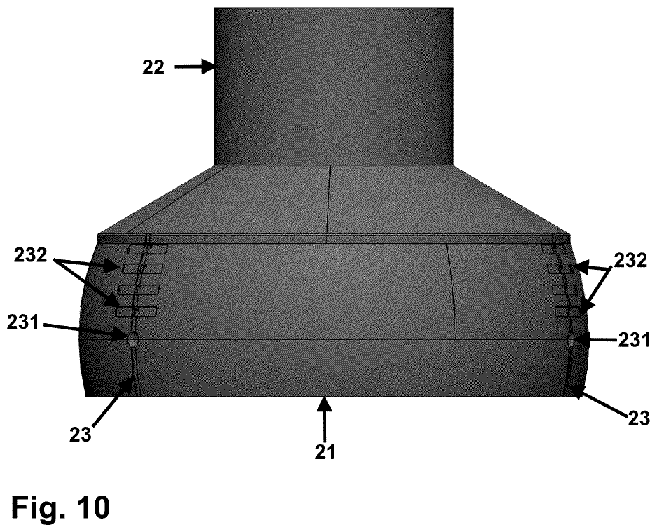

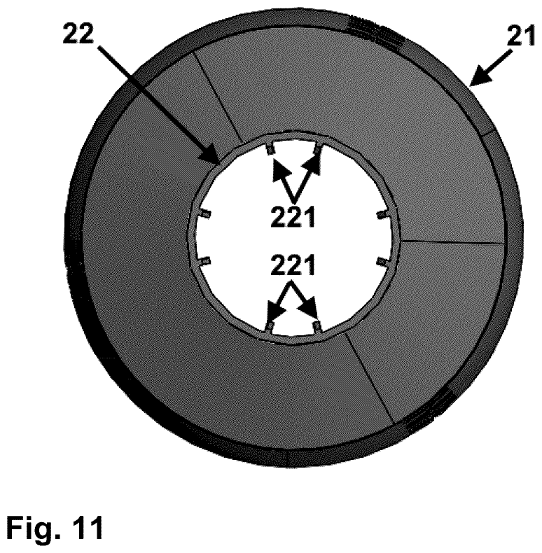

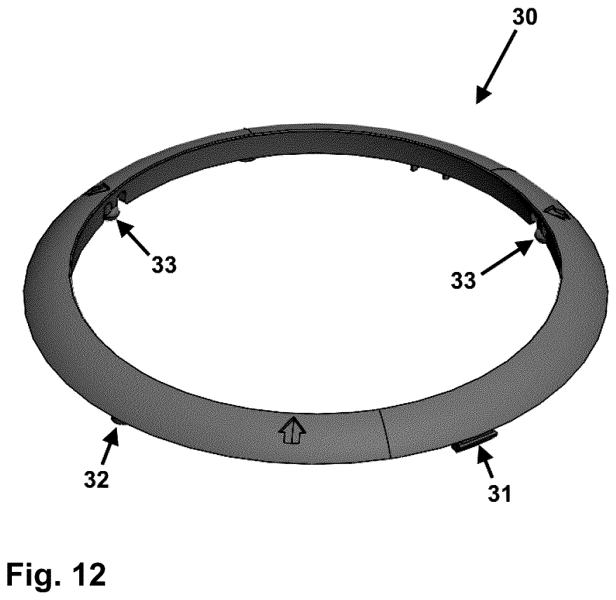

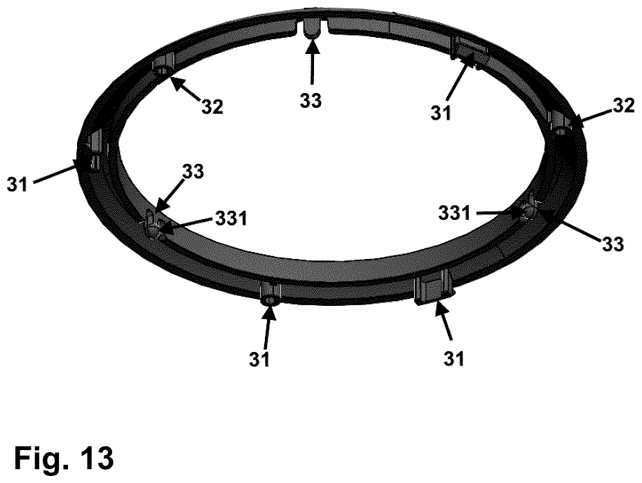

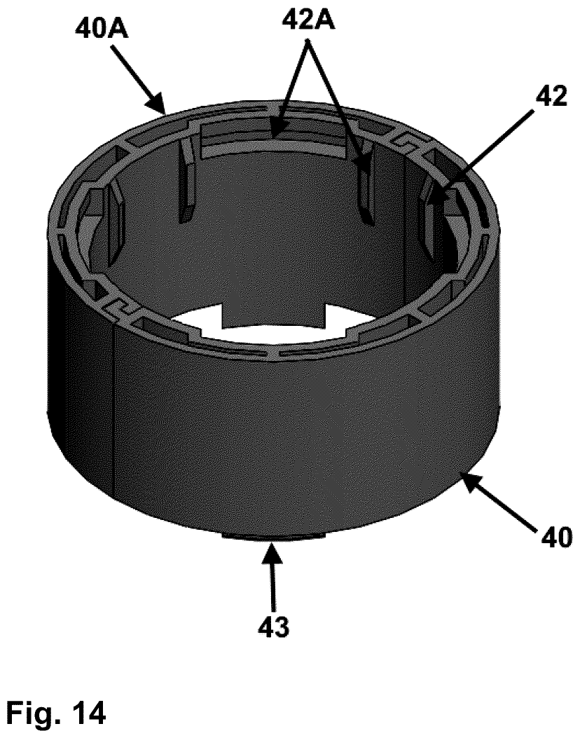

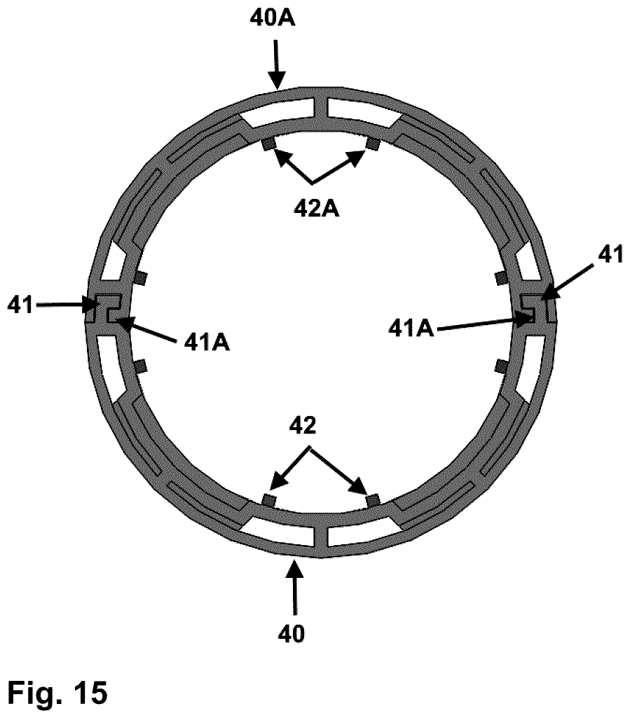

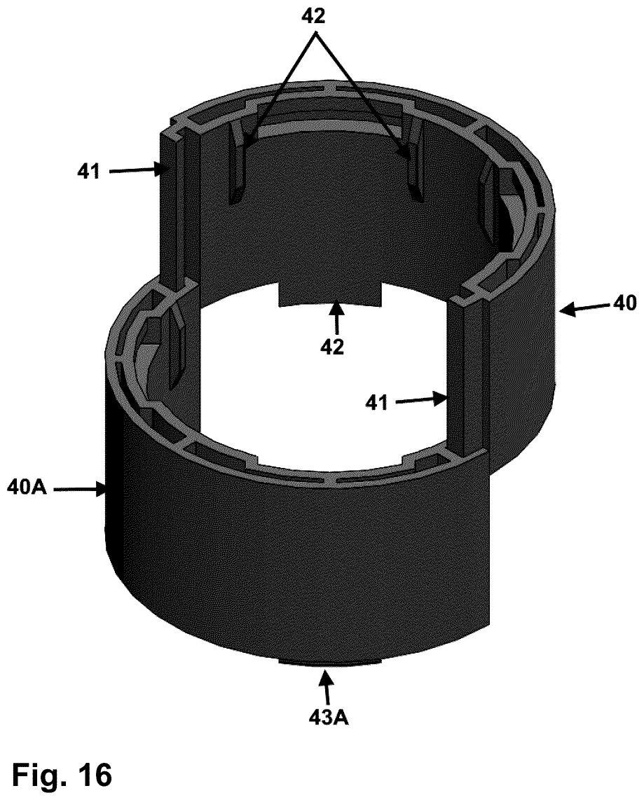

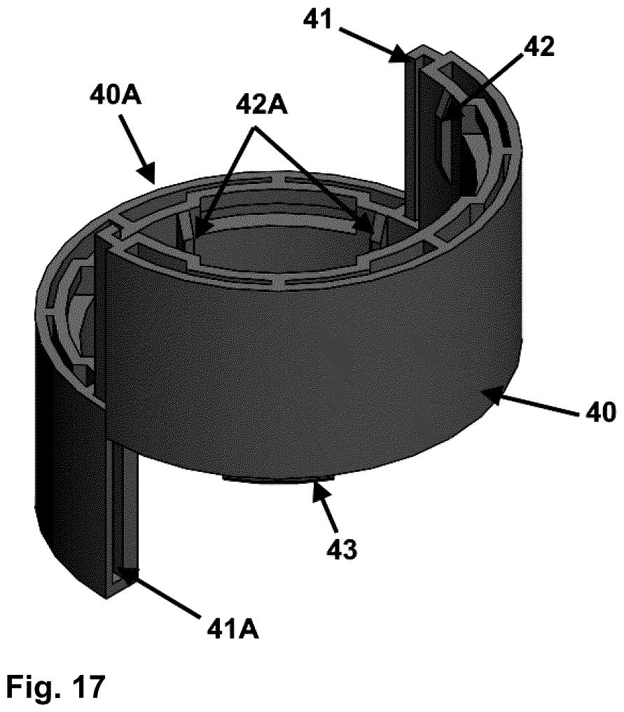

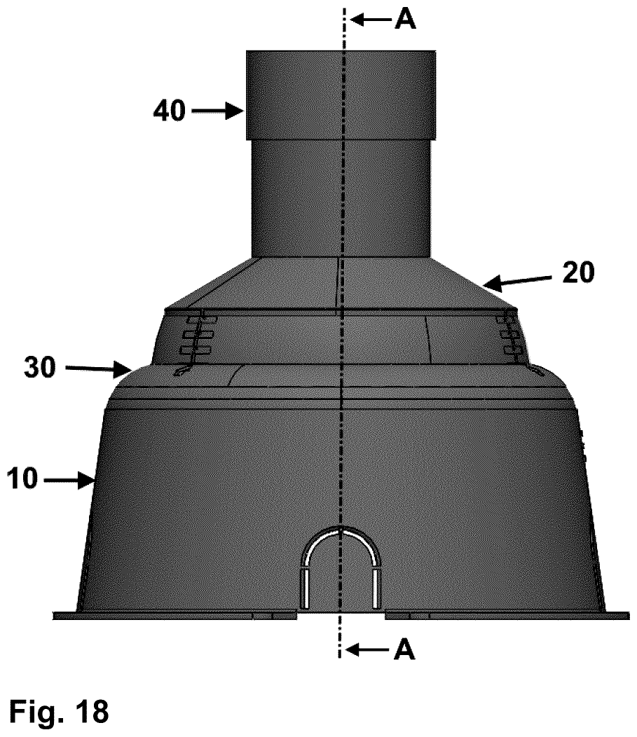

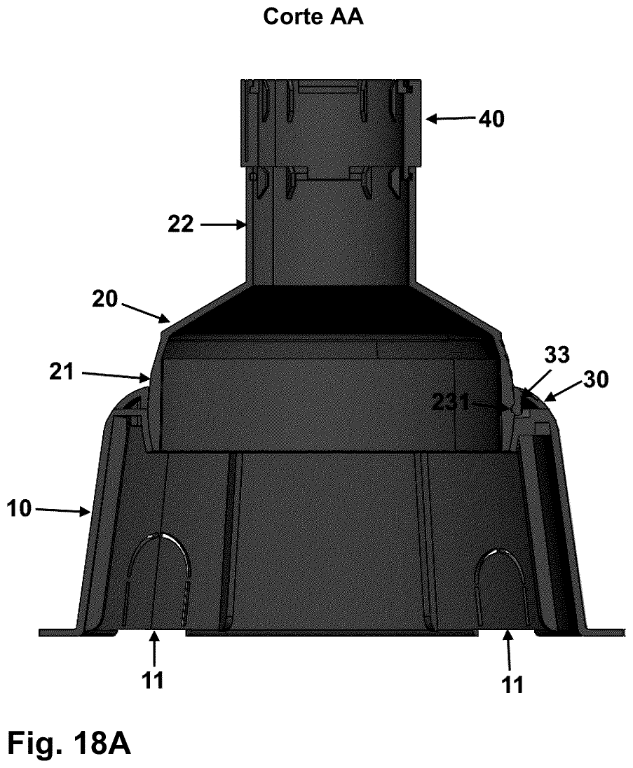

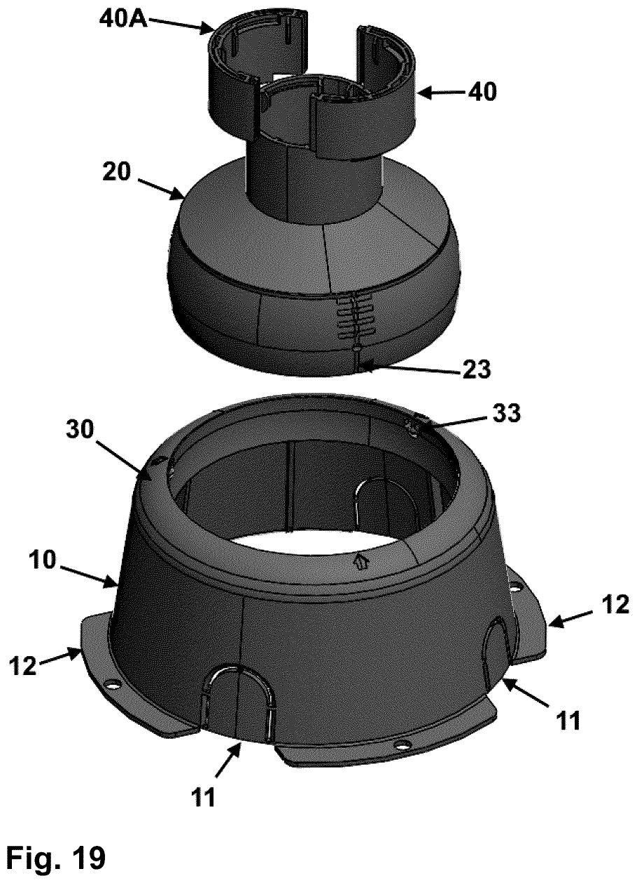

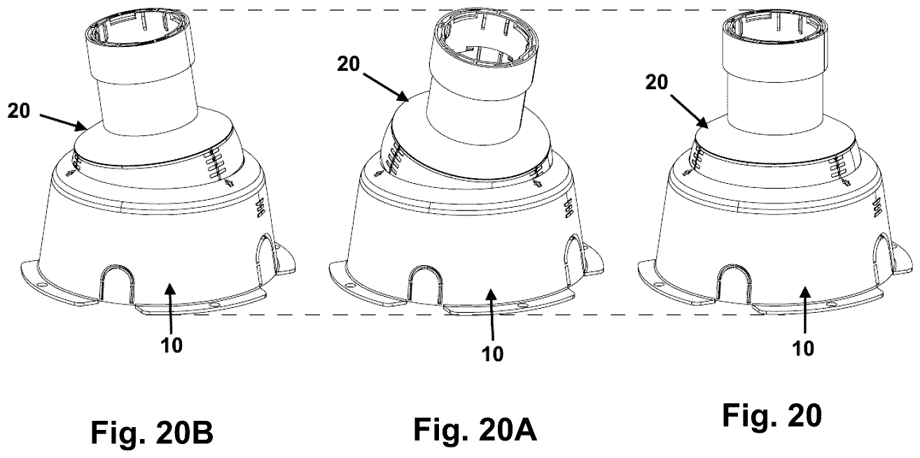

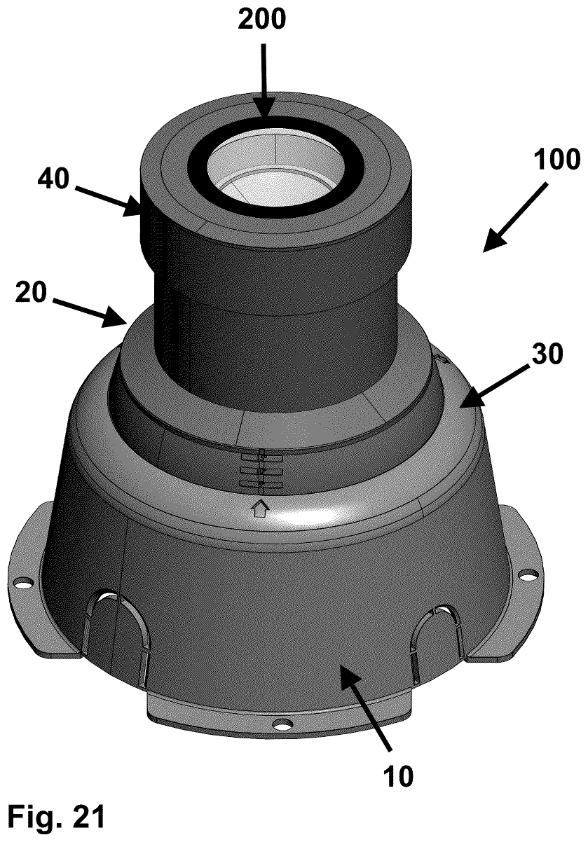

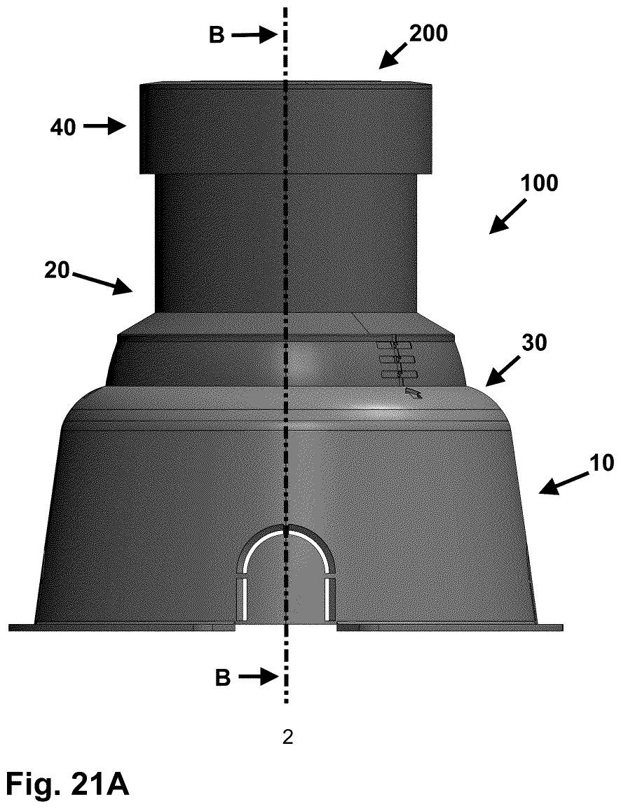

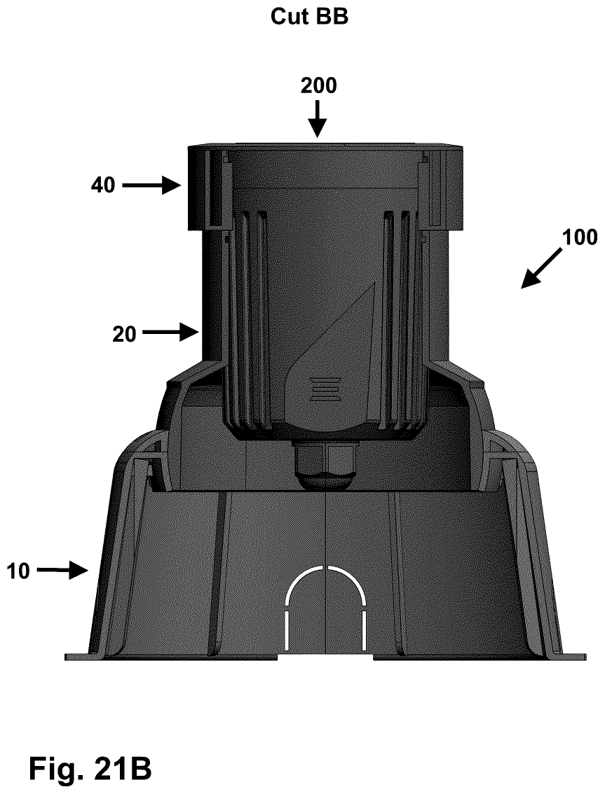

### DETAILED DESCRIPTION OF THE INVENTION

The installation box for recessed lighting on the floor, object of the present invention, comprises an installation box (100) for recessed floor lighting with wide space for storage of electrical splices, passage for ½″ and ¾″ corrugated hoses, orbital guidance, elevation rings and inclination markers for 4 different angles (0°, 5°, 10° and 15°).

This box (100) is made up of a base (10) where the passages (11) of the corrugated hoses are located, a ball joint (20) that allows orbital guidance, a ring (30) that fixes the ball joint to the base (10) and two pieces (40) (40A) forming the lifting ring.

The base (10) is equipped with passages (11), of varying sizes for ½″ and ¾″ hoses, and a lower tab (12) that allows the base (10) to be positioned close to the floor, said tab (12) having a hole (121) that allows the base to be locked close to the floor. In the upper portion, the base (10) has rectangular holes (13) and circular holes (14) that allow the ring (30) to be locked, in addition it has slots (15) that allow the positioning for locking and movement of the ball joint (20).

The ball joint (20) is equipped with a base (21) arranged next to the base (10) and a central projection (22) that allows the positioning of the luminaire, said base (21) having vertical slots (23) equipped with a circular bas-relief (231) and a set of horizontal slots (232) with graduation of degrees that allows the ball joint (20) to be positioned at the desired angle together with the ring (30). The projection (22) has a set of projections (221) that allows the positioning of the luminaire or the fitting of the sealing ring (40) (40A).

The ring (30) is equipped with rectangular projections (31) that fit together with the holes (13) and circular projections (32) that fit together with the holes (14) of the base (10), in addition it has projections (33) equipped with a spherical tip (331) that is positioned together with the slots (15) of the base (10), said projections (33) with a spherical tip (331) that are positioned together with the slots (23) in order to allow the movement of the ball joint (20).

The ball joint (20) can be moved by the slot (23) and slots (232) in order to position the ball joint at the desired angle, so that the standard positioning is when the projections (33) with spherical point are positioned next to the bas-relief (231).

The lifting ring is equipped with two parts (40) (40A) that together are positioned in the upper portion of the projection (22) of the ball joint (20) with the aim of extending the positioning of the luminaire arranged inside the box (100).

The lifting ring is fitted to the part (40) by male projections (41) at the ends that allow the fitting of the part (40A) fitted with female slots (41A) at the ends, forming a circular structure that is fitted together with the projections (221) of the ball joint (20) through the projections (42) (42A) arranged on the parts (40) (40A).

The product was designed to be produced in plastic and comprises a family of products with 4 (four) different sizes for installing luminaires of different sizes on the floor and masonry.

The lifting ring (40) (40A) is not a mandatory item in the assembly, so it is only used in cases where the installer identifies the need to better design the luminaire due to the positioning of the box (100) on the floor.

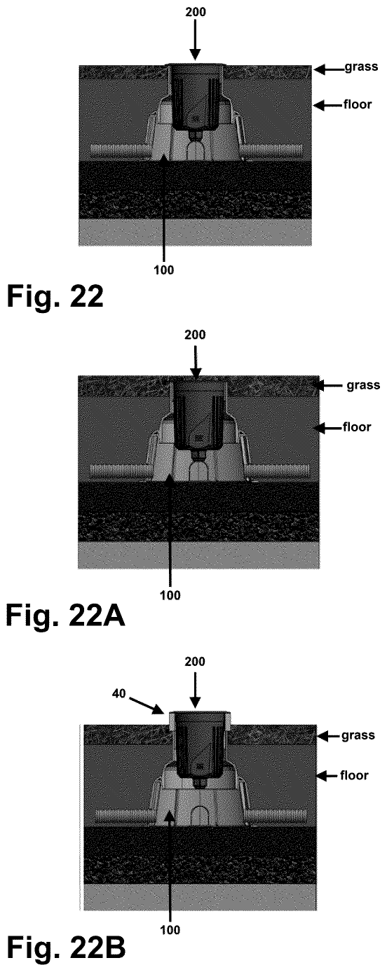

FIG. 22 shows the installation box (100) applied on the floor with the luminaire (200) embedded in the assembly so that the upper face of the luminaire (200) is aligned with the grass. FIG. 22A shows the box (100) with luminaire (200) where the grass extends beyond the upper face of the luminaire, requiring the application of the lifting ring (40) (40A). FIG. 22B Shows the box (100) with luminaire (200) with the application of the lifting ring (40) (40A) so as to project the luminaire above the grass, allowing for improved lighting without having to move the box (100).

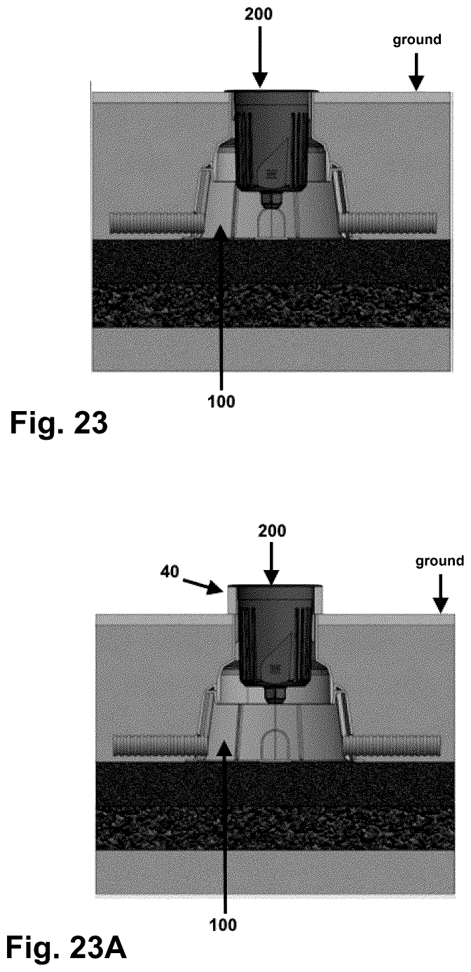

FIG. 23 shows the installation box (100) applied to a concrete floor with the luminaire (200) embedded in the assembly so that the upper face of the luminaire (200) is aligned with the floor. FIG. 23A shows the box (100) with the luminaire (200) with the application of the lifting ring (40) (40A) so as to project the luminaire above the floor, allowing for improved lighting without having to move the box (100).

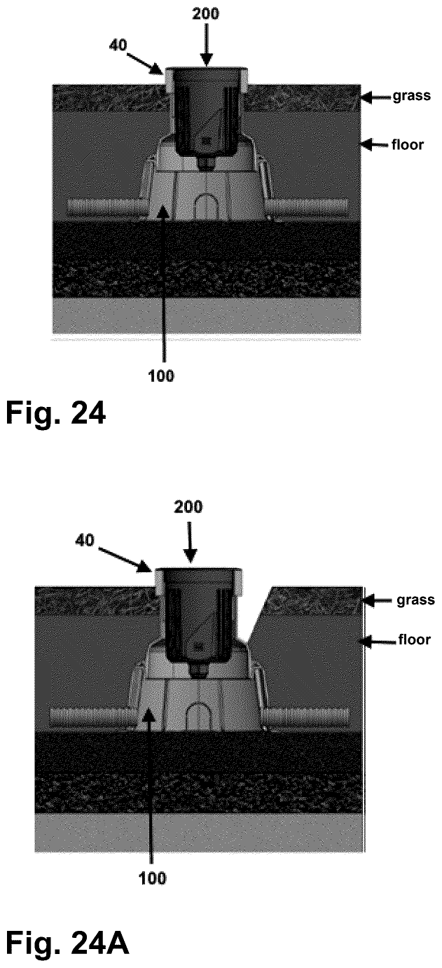

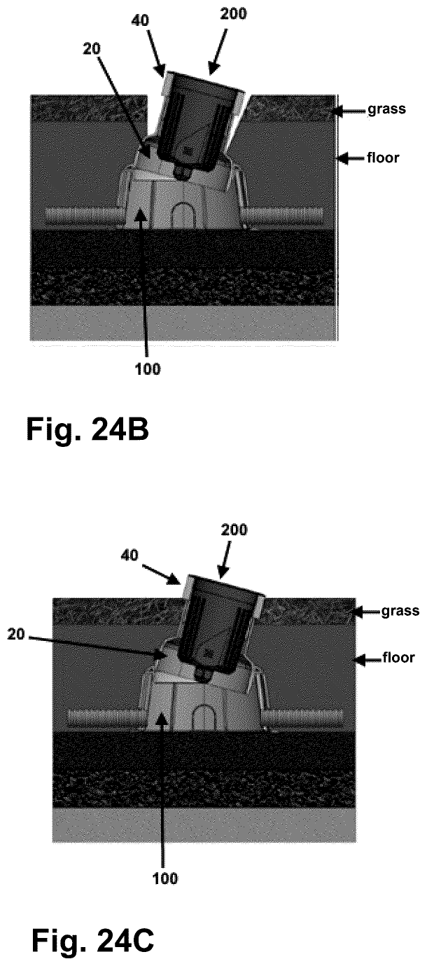

FIG. 24 shows the installation box (100) applied on the floor with the luminaire (200) embedded in the assembly, demonstrating its normal position with the application of the lifting ring (40) (40A). FIG. 24A shows the luminaire (200) and box (100) assembly with ground relief on one of its lateral faces. FIG. 24B shows the possibility of tilting the light beam through the orbital movement of the ball joint (20) of the box (100). FIG. 24C shows the ball joint (20) equipped with the luminaire (200) positioned at an inclination of 15° adjusted according to the slots (232).

1. INSTALLATION BOX FOR RECESSED LIGHTING ON THE FLOOR, characterized by having a box (100) composed of a base (10) where the passages (11) of the corrugated hoses are located, a ball joint (20) that allows orbital direction with inclination adjustment at angles of 0°, 5°, 10° and 15° degrees, a ring (30) that fixes the ball joint to the base (10) and two pieces (40) (40A) that form the ring for raising the luminaire in relation to the floor.

2. INSTALLATION BOX FOR RECESSED LIGHTING ON THE FLOOR, according to claim 1, characterized in that the base (10) is equipped with passages (11) of varying sizes for ½″ and ¾″ hoses, and by a lower tab (12) that allow the positioning of the base (10) close to the floor, said tab (12) having a hole (121) that allows the locking of the base close to the floor.

3. INSTALLATION BOX FOR RECESSED LIGHTING ON THE FLOOR, according to claim 2, characterized in that the upper portion of the base (10) has rectangular holes (13) and circular holes (14) that allow the locking of the ring (30), in addition it has grooves (15) that allow the positioning for locking and movement of the ball joint (20).

4. INSTALLATION BOX FOR RECESSED LIGHTING ON THE FLOOR, according to claim 1, characterized in that the ball joint (20) is equipped with a base (21) arranged next to the base (10) and a central projection (22) that allows the positioning of the luminaire.

5. INSTALLATION BOX FOR RECESSED LIGHTING ON THE FLOOR, according to claim 4, characterized in that the base (21) has vertical slots (23) equipped with a circular bas-relief (231) and a set of horizontal slots (232) with degree graduations that allow the ball joint (20) to be positioned at the desired angle together with the ring (30).

6. INSTALLATION BOX FOR RECESSED LIGHTING ON THE FLOOR, according to claim 4, characterized in that the projection (22) has a set of projections (221) that allows the positioning of the luminaire or the fitting of the sealing ring (40) (40A).

7. INSTALLATION BOX FOR RECESSED LIGHTING ON THE FLOOR, according to claim 1, characterized in that the ring (30) is equipped with rectangular projections (31) that fit together with the holes (13) and circular projections (32) that fit together with the holes (14) of the base (10).

8. INSTALLATION BOX FOR RECESSED LIGHTING ON THE FLOOR, according to claim 7, characterized by presenting projections (33) equipped with a spherical tip (331) that is positioned next to the slots (15) of the base (10), said projections (33) with a spherical tip (331) that are positioned next to the slots (23) in such a way as to allow the movement of the ball joint (20).

9. INSTALLATION BOX FOR RECESSED LIGHTING ON THE FLOOR, according to claim 1, characterized in that the ball joint (20) is moved by the slot (23) and slots (232) in order to position the ball joint at the desired angle, so that the standard positioning is when the projections (33) with spherical point are positioned next to the bas-relief (231).

10. INSTALLATION BOX FOR RECESSED LIGHTING ON THE FLOOR, according to claim 1, characterized in that the lifting ring is equipped with two pieces (40) (40A) that together are positioned in the upper portion of the projection (22) of the ball joint (20) with the aim of extending the positioning of the luminaire arranged inside the box (100).

11. INSTALLATION BOX FOR RECESSED LIGHTING ON THE FLOOR, according to claim 10, characterized in that the lifting ring is provided on the part (40) with male projections (41) at the ends that allow the fitting of the part (40A) provided with female slots (41A) at the ends, forming a circular structure that is fitted together with the projections (221) of the ball joint (20) through the projections (42) (42A) arranged on the parts (40) (40A).
